(19) United States
(12) Patent Application Publication
(10) Pub. No.: US 2025/0306814 A1
(43) Pub. Date: Oct. 2, 2025

(54) IMAGE PROCESSING METHOD, IMAGE PROCESSING DEVICE, PRINTING SYSTEM, AND NON-TRANSITORY COMPUTER-READABLE STORAGE MEDIUM STORING IMAGE PROCESSING PROGRAM

(71) Applicant: SEIKO EPSON CORPORATION, Tokyo (JP)

(72) Inventors: Takuya ONO, SHIOJIRI-SHI (JP); Takahiro KAMADA, MATSUMOTO-SHI (JP); Mitsuhiro YAMASHITA, MATSUMOTO-SHI (JP); Yuko YAMAMOTO, SHIOJIRI-SHI (JP)

(21) Appl. No.: 19/091,268

(22) Filed: Mar. 26, 2025

(30) Foreign Application Priority Data
Mar. 28, 2024 (JP) 2024-053828

(51) Int. Cl. G06F 3/12; G06F 3/04815

(52) U.S. Cl. CPC G06F 3/1208; G06F 3/04815; G06F 3/1256

(57) ABSTRACT

A preview image representing the virtual three dimensional object of the printed matter that superimposed and combined in the stacking order of one or more print layers and a print medium, and the preview image processing method includes displaying, on a display device, the preview image corresponding to appearance in a three dimensional virtual space; receiving a change instruction to change the appearance of the three dimensional object; changing a posture of the three dimensional object in the virtual space and at least one of a viewpoint position and a viewing direction of a virtual camera with respect to the three dimensional object in the virtual space so that the appearance of the three dimensional object is changed in accordance with the change instruction, and displaying the preview image representing the three dimensional object after the change on the display device; and displaying, on the display device, together with the preview image, display information indicating the appearance of the three dimensional object represented by the preview image that is presently being displayed.

The present application is based on, and claims priority from JP Application Serial Number 2024-053828, filed Mar. 28, 2024, the disclosure of which is hereby incorporated by reference herein in its entirety.

### BACKGROUND

### 1. Technical Field

The present disclosure relates to an image processing method, an image processing device, a printing system, and an image processing program.

### 2. Related Art

JP-A-2019-201264 describes a technique in which, when printing is performed on a transparent medium, preview images indicating the front side and the rear side of the printed print medium are displayed. In the technology described in JP-A-2019-201264, the display of the preview image is switched when an instruction is received from the user to display a preview image of either the front side or the rear side of the print medium that is different from the currently displayed preview image.

In a case where printing is performed on a transparent medium, the printed image can also be visually checked from the rear side. For this reason, it is assumed that it is difficult for the user to recognize whether the currently displayed screen is the front side or the rear side while the display is repeatedly switched between the previewing image of the front side and the previewing image of the rear side. For this reason, a technique with good operability for the user has been desired.

### SUMMARY

The present disclosure can be implemented as the following aspects.

According to a first aspect of the present disclosure, an image processing method is provided. The image processing method includes a step (a) of receiving a layering order of one or more print layers, which are to be layered on a print medium by printing on the print medium, and the print medium; a step (b) of displaying, on a display device, a preview image representing a virtual three dimensional object of printed matter in which the one or more print layers and the print medium are superimposed and combined in the layering order, the preview image corresponding to an appearance in a three dimensional virtual space; a step (c) of receiving a change instruction to change the appearance of the three dimensional object; a step (d) of changing, so that the appearance of the three dimensional object is changed in accordance with the change instruction, at least one of a posture of the three dimensional object in the virtual space, or a viewpoint position and a viewing direction of a virtual camera with respect to the three dimensional object in the virtual space, and of displaying, on the display device, the preview image representing the three dimensional object after changing; and a step (e) of displaying, on the display device together with the preview image, display information indicating appearance of the three dimensional object represented by the currently displayed preview image.

According to a second aspect of the present disclosure, an image processing device is provided. The image processing device displays a print setting reception section that receives a layering order of one or more print layers, which are to be layered on a print medium by printing on the print medium, and the print medium; a display processing section configured to display, on a display device, a preview image representing a virtual three dimensional object of printed matter in which the one or more print layers and the print medium are superimposed and combined in the layering order, the preview image corresponding to an appearance in a three dimensional virtual space; and a change reception section configured to receive a change instruction to change the appearance of the three dimensional object, wherein the display processing section when the change reception section receives the change instruction, changes at least one of a posture of the three dimensional object in the virtual space, or a viewpoint position and a viewing direction of a virtual camera with respect to the three dimensional object in the virtual space, so that the appearance of the three dimensional object is changed in accordance with the change instruction and displays, on the display device, the preview image representing the three dimensional object after changing, and the display information indicating appearance of the three dimensional object represented by the preview image after changing.

According to a third aspect of the present disclosure, a printing system is provided. The printing system includes an image processing device, a printing device, and a display device. The image processing device includes a print setting reception section that receives a layering order of one or more print layers, which are to be layered on a print medium by printing on the print medium, and the print medium; a display processing section configured to display, on the display device, a preview image representing a virtual three dimensional object of printed matter in which the one or more print layers and the print medium are superimposed and combined in the layering order, the preview image corresponding to an appearance in a three dimensional virtual space; and a change reception section configured to receive a change instruction to change the appearance of the three dimensional object, wherein the display processing section when the change reception section receives the change instruction, changes at least one of a posture of the three dimensional object in the virtual space, or a viewpoint position and a viewing direction of a virtual camera with respect to the three dimensional object in the virtual space, so that the appearance of the three dimensional object is changed in accordance with the change instruction and displays, on the display device, the preview image representing the three dimensional object after changing, and the display information indicating appearance of the three dimensional object represented by the preview image after changing.

According to a fourth aspect of the present disclosure, a non-transitory computer-readable storage medium storing an image processing program is provided. The non-transitory computer-readable storage medium storing an image processing program includes a function (a) of receiving a layering order of one or more print layers, which are to be layered on a print medium by printing on the print medium, and the print medium; a function (b) of displaying, on a display device, a preview image representing a virtual three dimensional object of printed matter in which the one or more print layers and the print medium are superimposed and combined in the layering order, the preview image corresponding to an appearance in a three dimensional virtual space; a function (c) of receiving a change instruction to change the appearance of the three dimensional object; a function (d) of changing, so that the appearance of the three dimensional object is changed in accordance with the change instruction, at least one of a posture of the three dimensional object in the virtual space, or a viewpoint position and a viewing direction of a virtual camera with respect to the three dimensional object in the virtual space, and of displaying, on the display device, the preview image representing the three dimensional object after changing; and a function (e) of displaying, on the display device together with the preview image, display information indicating appearance of the three dimensional object represented by the currently displayed preview image.

### BRIEF DESCRIPTION OF THE DRAWINGS

FIG. 1 is a block diagram illustrating a schematic configuration of a printing system according to an embodiment.

FIG. 2 is an explanatory view showing a printed matter in which an image is printed on a transparent print medium.

FIG. 3 is an explanatory diagram illustrating another example of printed matter in which an image is printed on a transparent print medium.

FIG. 4 is an explanatory diagram showing a configuration of the image processing device.

FIG. 5 is an explanatory diagram showing an example of a user interface for inputting image data.

FIG. 6 is an explanatory diagram of an input operation in the user interface.

FIG. 7 is an explanatory diagram illustrating the processing of the pre-process section.

FIG. 8 is an explanatory diagram illustrating the processing of the pre-process section.

FIG. 9 is an explanatory diagram showing a configuration of a rendering section.

FIG. 10 is a flowchart illustrating a process related to the printing process executed in the image processing device.

FIG. 11 is an explanatory view schematically showing a state in which a front side of a printed matter represented as a three dimensional object in a virtual space is observed.

FIG. 12 is an explanatory diagram schematically illustrating a state in which the rear side of the printed matter represented as a 3D object in the virtual space is observed.

FIG. 13 is a flowchart showing the display switching process.

FIG. 14 is an explanatory diagram illustrating a state in which the image processing device displays a rendering image again in response to a touch operation.

FIG. 15 is an explanatory view of the effect of the present embodiment.

FIG. 16 is an explanatory diagram of a mode of displaying display information according to the first alternative embodiment.

FIG. 17 is a flowchart illustrating a display switching process according to the second alternative embodiment.

FIG. 18 is an explanatory diagram showing an example of a display mode of a preview image according to a second alternative embodiment.

FIG. 19 is an explanatory diagram showing a positional relationship between a virtual object representing a printed matter and a camera placed in a virtual space.

FIG. 20 is an explanatory diagram of a user interface according to a fourth alternative embodiment.

### DESCRIPTION OF EMBODIMENTS

### A. Embodiments

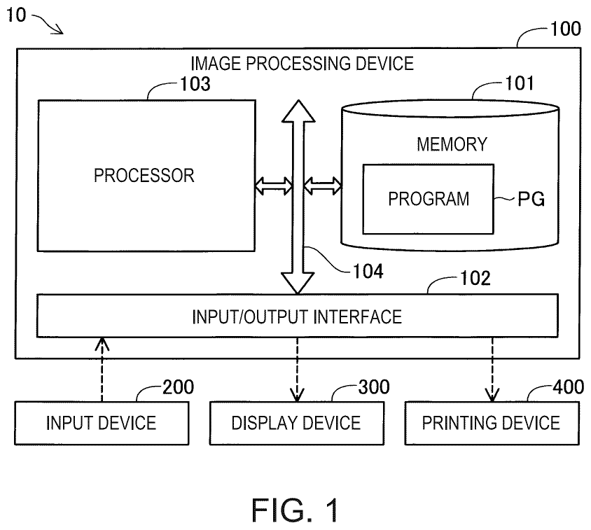

FIG. 1 shows a block diagram illustrating a schematic configuration of a printing system 10 according to the present embodiment. The printing system 10 includes an image processing device 100, an input device 200, a display device 300, and at least one printing device 400. The printing system 10 functions as a printing device in a broad sense.

The image processing device 100 generates a rendering image corresponding to the appearance of printed matter in a three dimensional virtual space by physical based rendering (hereinafter simply referred to as rendering). The image processing device 100 causes the display device 300 to display the generated rendering image as the preview image before execution of printing. In the present embodiment, the appearance of the printed matter in the three dimensional virtual space is defined by the posture of the three dimensional object in the virtual space or the viewpoint position and viewing direction of the virtual camera with respect to the three dimensional object in the virtual space. The user can see the 3D object representing the printed matter in the virtual space at the viewpoint position and the viewing direction of the virtual camera.

The printing device 400 is an inkjet type printing device and directly prints an image on a print medium. In the present embodiment, the printing device 400 prints an image on a transparent print medium. The print medium has a flat plate shape. As the print medium, a transparent film or sheet made of materials such as polypropylene (PP), polyethylene (PE), or polyvinyl chloride (PVC) can be used. Additionally, as the print medium, a plate formed of transparent materials such as acrylic or glass can be used. However, the print medium may be translucent. The transparent print medium may be a medium that has an average transmittance of visible light of 80% or more, for example. The translucent print medium may be a medium that has an average visible light transmittance of 30% or more and less than 80%, for example. In present embodiment, processing will be described for the case where a transparent print medium is used. Substantially the same processing can be applied to both the case of using a translucent print medium and the case of using an opaque print medium.

The printing device 400 can perform rear side printing in addition to front side printing. Front side printing refers to printing on the front surface of the print medium. In the present disclosure, the front side of the print medium refers to a surface on the side on which the printed matter is assumed to be observed. The rear side is a surface opposite to the front side. Rear side printing refers to printing on the rear side of a transparent print medium with the direction of the image and the order of overprint reversed. The rear side printed image is visible through the transparent print medium. By rear side printing, printed matters with transparency or gloss can be obtained. Some examples of front side printing and rear side printing will be described below.

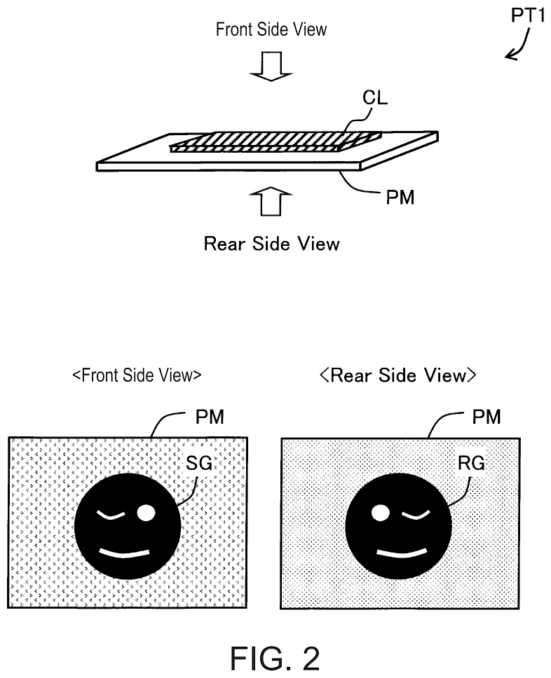

FIG. 2 is an explanatory diagram illustrating the example of a printed matter PT1 in which an image is printed on a transparent print medium. With respect to the printed matter PT1, a color layer CL, on which a front side image SG is formed, is formed on the front side of a transparent print medium PM. The printed matter PT1 is printed by front side printing. The color layer CL is formed by the printing of plates for each color of the process colors. The color layer CL is formed by a set of process ink dots. The thicknesses of the layers are exaggerated for convenience of illustration. The printed matter PT1 is assumed to be observed only from the front side, but when observed from the rear side, the rear side image RG, which is a horizontally inverted image of the front side image SG, can be seen. The horizontally inverted image is also referred to as a mirror-inversion image.

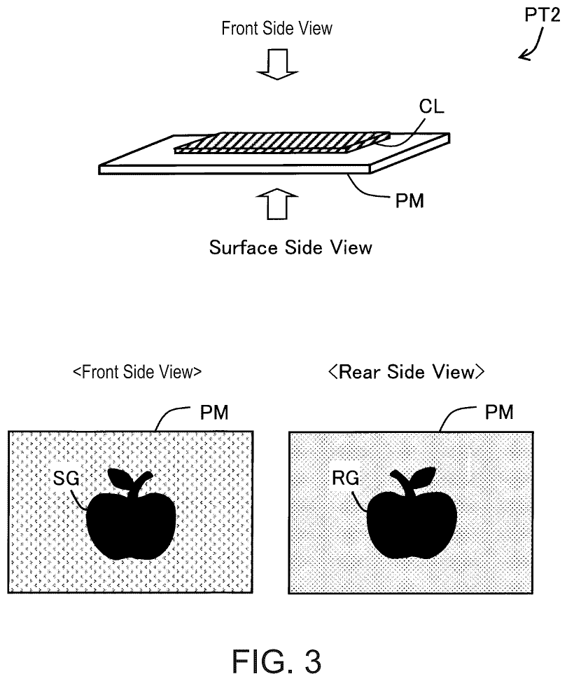

FIG. 3 is an explanatory diagram illustrating another example of printed matter in which an image is printed on a transparent print medium. In FIG. 3, the thicknesses of the layers are exaggerated for convenience of illustration.

In the printed matter PT2 of FIG. 3, the color layer CL forming the rear side image RG is printed on the rear surface of the transparent print medium PM. The printed matter PT2 is printed by rear side printing. FIG. 3 shows a state of the printed matter PT2 in which is arranged such that the rear side of print medium PM is positioned on the upper side. Since the print medium PM is transparent, when observed from the front side, the front side image SG, which is a horizontally inverted image of the rear side image RG, is seen through the print medium PM.

As illustrated in FIG. 1, the image processing device 100 is a computer including a memory 101, an input/output interface 102, a processor 103, and an internal bus 104. The memory 101, the input/output interface 102, and the processor 103 are communicably coupled via the internal bus 104. The memory 101 stores various programs and various data used for various processes executed by the image processing device 100. A program PG is stored in the memory 101. The input device 200, the display device 300, and the printing device 400 are coupled to the input/output interface 102 by wired communication or wireless communication. The processor 103 realizes various functions by executing the program stored in the memory 101. The input device 200 is, for example, a keyboard or a mouse. The display device 300 is, for example, a liquid crystal display or an organic electro luminescence (EL) display. In the present embodiment, the display device 300 further includes a function as a pointing device.

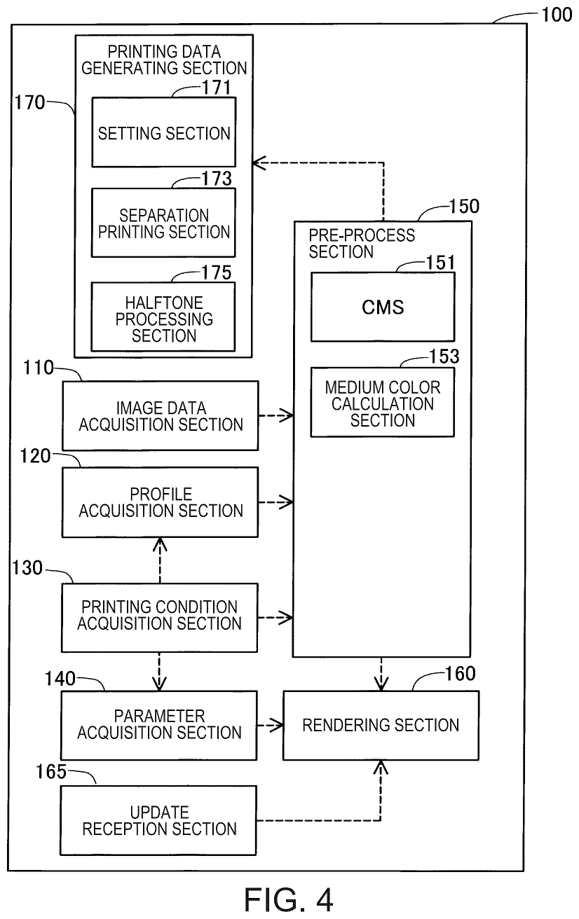

FIG. 4 is an explanatory diagram showing configuration of the image processing device 100. The image processing device 100 includes an image data acquisition section 110, a profile acquisition section 120, a printing condition acquisition section 130, a parameter acquisition section 140, a pre-process section 150, a rendering section 160, an update reception section 165, and a print data generating section 170. The functions of these units are realized by the processor 103 executing the program PG stored in the memory 101 illustrated in FIG. 1. The rendering section 160 is also referred to as a “display processing section”.

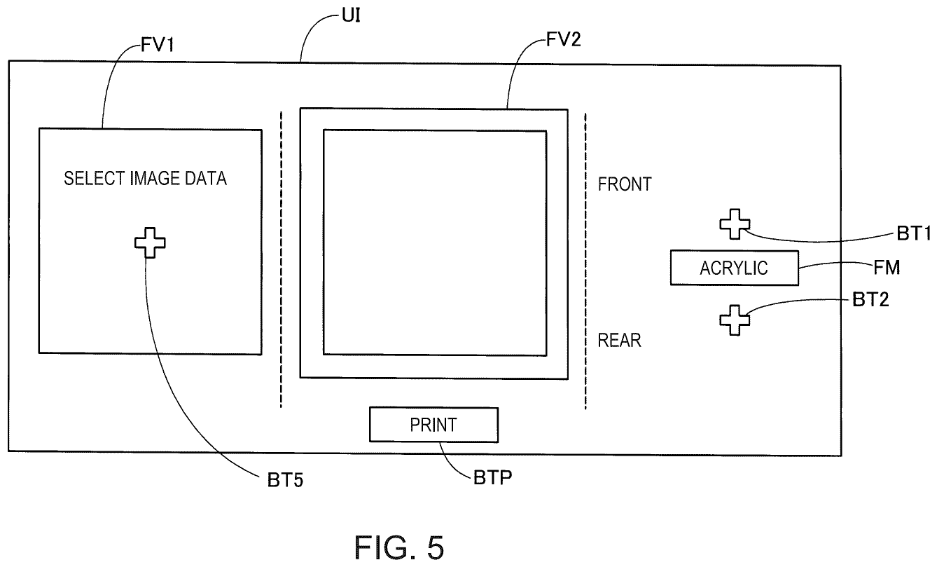

FIG. 5 is an explanatory diagram showing an example of a user interface UI for inputting image data. The user interface UI is displayed on the display device 300 under the control of the processor 103. Here, an example in which an acrylic plate is used as the print medium PM will be described.

The user interface UI includes a display region FM for displaying the type of print medium PM, a button BT1 for adding a print layer to be superimposed on the front side of the print medium PM, a button BT2 for adding a print layer to be superimposed on the rear side of the print medium PM, a display region FV1 for displaying an image selected by the user, a display region FV2 for displaying a preview image, a button BT5 for selecting an image to be printed, and a print button BTP for instructing the start of printing. The print layers are layers formed by ink.

When the user taps the button BT1, it is possible to add a color layer to be arranged on the front side of the acrylic plate as the print medium PM. When the user taps the button BT2, it is possible to add a color layer to be arranged on the rear side of the acrylic plate as the print medium PM. In the present embodiment, in order to facilitate understanding of the technique, it is assumed that the color layer is arranged on only one of the front side and the rear side of the print medium PM.

When the user taps a button BT5 in the display region FV1, data of a list (not shown) of images stored in a predetermined region of the memory 101 of the image processing device 100 is displayed. Therefore, the user can select desired image data. An image selected by the user is displayed in the display region FV1. When no image is selected, no image is displayed in the display region FV1.

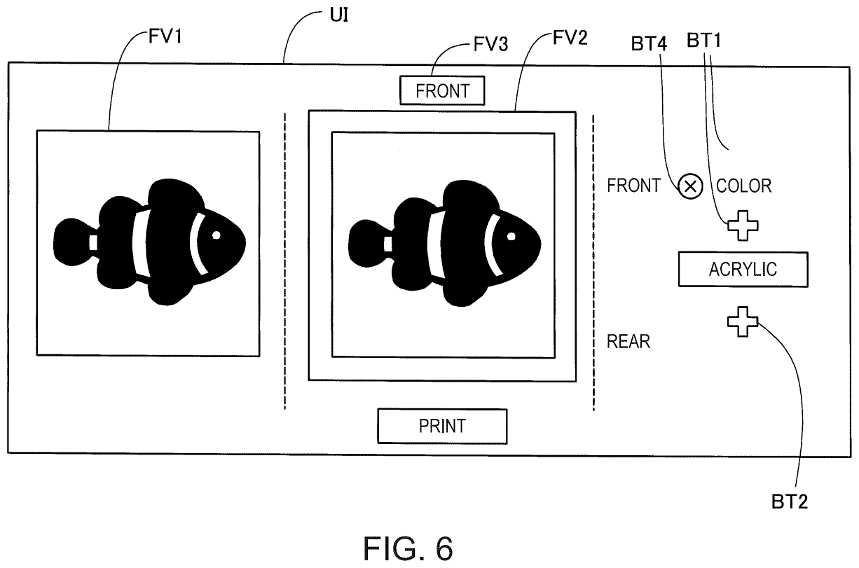

FIG. 6 is an explanatory diagram of an input operation in the user interface UI. FIG. 6 illustrates the user interface UI representing a state after the user has added a color layer and selected image data. In the illustrated example, a color layer is added to the front side of an acrylic plate as the print medium PM.

On the user interface UI, a button BT4 for deleting each color layer added by the user is displayed. The user can delete the added color layer by tapping the button BT4.

When image data is selected for the added color layer, a preview image is displayed in the display region FV2. As an initial setting, a preview image representing the front side of the printed matter is displayed in the display region FV2. In the present embodiment, a preview image representing the front side of the printed matter or a preview image representing the rear side of the printed matter is displayed in the display region FV2. Further, display screen information indicating which of the front side and the rear side of the printed matter is displayed as a preview image is displayed in the display region FV3. The user can give an instruction to change the appearance of the printed matter represented by the preview image displayed in the display region FV2 by tapping the preview image displayed in the display region FV2. When the operation instruction of the user is received, the rendering section 160 described below updates the display of the rendering image displayed in the display region FV2.

The image data acquisition section 110 illustrated in FIG. 4 obtains an image selected by the user from a list (not illustrated) of images stored in the memory 101 of the image processing device 100 displayed by tapping the button BT5. The selected image data is referred to as input image data IMi. The input image data IMi represents an image to be formed on the print medium PM. The input image data IMi is sent to the pre-process section 150.

The profile acquisition section 120 acquires the input profile IPF, the media profile MPF, and the common color space profile CPF stored in advance in the memory 101. In FIG. 1, illustration of the input profile IPF, the media profile MPF, and the common color space profile CPF is omitted. The input profile IPF, the media profile MPF, and the common color space profile CPF are used for color conversion by a color management system 151 of the pre-process section 150 (to be described later). Details of each profile will be described later. Each acquired profile is sent to the pre-process section 150. Note that the profile acquisition section 120 may acquire each profile from an external server via a network (not shown).

The printing condition acquisition section 130 acquires printing conditions. The printing conditions include conditions such as the type of print medium, the type of printing, the layering order indicating the order in which the print medium and one or more print layers are stacked, the type of ink of the print layer, the resolution of printing, and the type of printing device. When the print medium has a flat plate shape, the layering order refers to an order in which the print medium and one or more print layers are laminated with the front side of the print medium facing upward. In the case of front side printing, the layering order from the lower side is the print medium and the print layers. In the case of rear side printing, the layering order from the lower side is the print layer and the print medium. The printing conditions acquired by the printing condition acquisition section 130 are transmitted to the profile acquisition section 120, the parameter acquisition section 140, and the pre-process section 150. The printing condition acquisition section 130 is also referred to as a “print setting reception section”.

The parameter acquisition section 140 acquires various parameters used for rendering from the memory 101. Various parameters are stored in the memory 101 in advance. The various parameters used for rendering include, for example, three dimensional object information (hereinafter referred to as 3D object information), camera information, lighting information, and medium parameter. The 3D object information is a parameter relating to the shape of the print medium as a three dimensional object (hereinafter referred to as a 3D object) arranged in the virtual space. The camera information is a parameter related to the position and direction of the camera arranged in the virtual space. The lighting information consists of parameters related to the type of light source arranged in the virtual space, the position and direction of the light source, the color, and the luminous intensity (quantity of light). The types of light sources include, for example, fluorescent lamps and incandescent bulbs.

The print medium parameter is a parameter related to the texture of the print medium. In the present embodiment, the medium parameter includes a texture parameter representing the texture of the print medium and a translucency parameter representing the translucency of the print medium. The texture parameters include, for example, a base color relating to the base color of the print medium, smoothness representing the smoothness of the print medium, metallic representing the metallic property of the print medium, a normal line map, and a height map. When the metallic property is high, surrounding scenery is likely to be reflected on the print medium. Each of the texture parameters may include roughness representing the roughness of the print medium instead of smoothness. The normal line map and the height map are used to represent minute unevenness of the print medium that affects the reflection of light. The normal line map is a texture representing a distribution of normal line vectors of a minute uneven surface. The height map is a texture representing the distribution of the height of the minute uneven surface. When the size of the polygons constituting the 3D object is reduced to represent minute unevenness, the number of polygons becomes enormous, and the computational load of rendering increases. By using the normal line map and the height map, it is possible to express the influence of the minute uneven surface on the reflection of light without reducing the size of the polygon. The translucency parameter includes a medium transparency representing the transmittance (transparency) of light of the print medium. The translucency parameter may include a media opacity representing the opaque degree (opacity) of the print medium.

The various parameters acquired by the parameter acquisition section 140 are sent to the rendering section 160. The parameter acquisition section 140 may acquire various parameters from an external server via a network (not shown).

The pre-process section 150 includes a color management system 151 and a medium color calculation section 153. Hereinafter, the color management system 151 may be simply referred to as CMS 151.

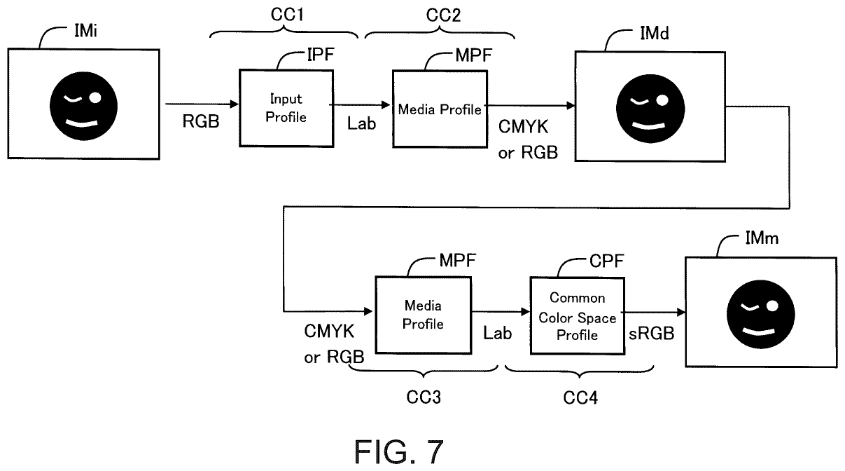

FIG. 7 is an explanatory diagram showing the processing contents of the CMS 151. The CMS 151 executes various kinds of color conversion processing using each profile acquired by the profile acquisition section 120.

The input profile IPF is an international color consortium (ICC) profile used for color conversion from a color space (input color space) of image data to a device-independent color space. The input color space is, for example, an RGB color space. The device-independent color space is, for example, the CIE-L*a*b* color space. The media profile MPF is an ICC profile used for color conversion from a device-independent color space to a device-dependent color space for the printing device 400. The device-dependent color space for the printing device 400 is, for example, a CMYK color space. The color of the device-dependent color space for the printing device 400 is also referred to as a device color. The common color space profile is an ICC profile used for color conversion from a device-independent color space to a color space for rendering. The color space for rendering is, for example, sRGB, AdobeRGB, and Display-P3.

An example of the color conversion processing executed by the CMS 151 is as follows. The CMS 151 sequentially performs the following color conversion processing for the input image data IMi.
(1) A first color conversion CC1 from an input color space to a device-independent space using an input profile IPF.
(2) A second color conversion CC2 from the device-independent color space to the device-dependent color space for the printing device 400 using the media profile MPF.
(3) A third color conversion CC3 from the device-dependent color space for the printing device 400 to the device-independent color space using the media profile MPF.
(4) A fourth color conversion CC4 from the device-independent color space to the rendering color space using the common color space profile CPF.

Through the first color conversion CC1 and the second color conversion CC2, the color values of the image data are converted into a range that can be represented by printing. In other words, by the first color conversion CC1 and the second color conversion CC2, the color value of the image data is converted into the color value of the color space depending on the printing device and the print medium. The image data subjected to the first color conversion CC1 and the second color conversion CC2 is referred to as device color image data IMd. The device color image data IMd is transmitted to the print data generating section 170 (see FIG. 4). For example, since images are printed on both sides of the print medium PM, a plurality of pieces of input image data IMi may be prepared. In this case, a plurality of sets of device color image data IMd are obtained by the color conversion process for each input image data IMi.

As shown in FIG. 7, by the third color conversion CC3 and the fourth color conversion CC4, the color value of the image data is converted into a range that can be represented by rendering. By performing the first color conversion CC1 to the fourth color conversion CC4, the color value of the image data is converted into the color value of the rendering color space. The image data converted into the color value of the rendering color space is referred to as rendering image data IMm. The rendering image data IMm is used as a texture to be added to a polygon representing the color layer CL in rendering. The RGBA values of the base colors of the color layer CL are set to (1,1,1,1). The rendering image data IMm is transmitted to the rendering section 160 (see FIG. 4). For example, since images are printed on both side of the print medium PM, a plurality of sets of input image data IMi may be input. In this case, a plurality of sets rendering image data IMm are obtained by the color conversion process for each set of input image data IMi.

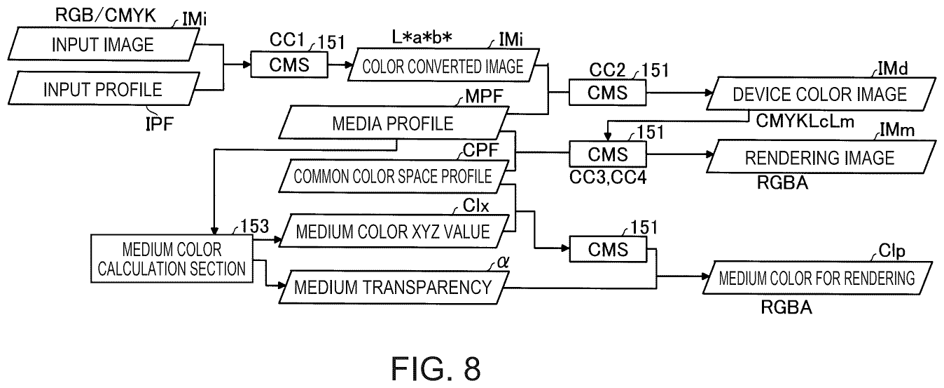

FIG. 8 is an explanatory diagram showing flow of a color conversion process. In FIG. 8, for convenience of description, a plurality of CMS 151 is illustrated, but these are the same CMS 151.

The medium color calculation section 153 acquires the XYZ values representing the color of the print medium PM from the media profile MPF. In the media profile MPF, the XYZ values representing the color of the print medium PM are stored in advance. The CMS 151 uses the common color space profile CPF to convert the XYZ value Clx representing the colors of the print medium PM into RGB values. Further, the medium color calculation section 153 acquires the medium transparency a indicating the transmittance (transparency) of light of the print medium. The medium transparency is included in the medium parameter acquired by the parameter acquisition section 140. The medium color calculation section 153 combines the medium transmittance a together with the RGB value obtained by converting the XYZ value Clx that represents the color of the print medium PM and outputs it as an RGBA value that represents the rendering medium color Clp to the rendering section 160.

The rendering section 160 generates a rendering image representing how a print medium on which an image is printed looks in a virtual space. In rendering process, the printed matter is represented as a 3D object in a virtual space. The rendering section 160 is also referred to as a “display processing section”.

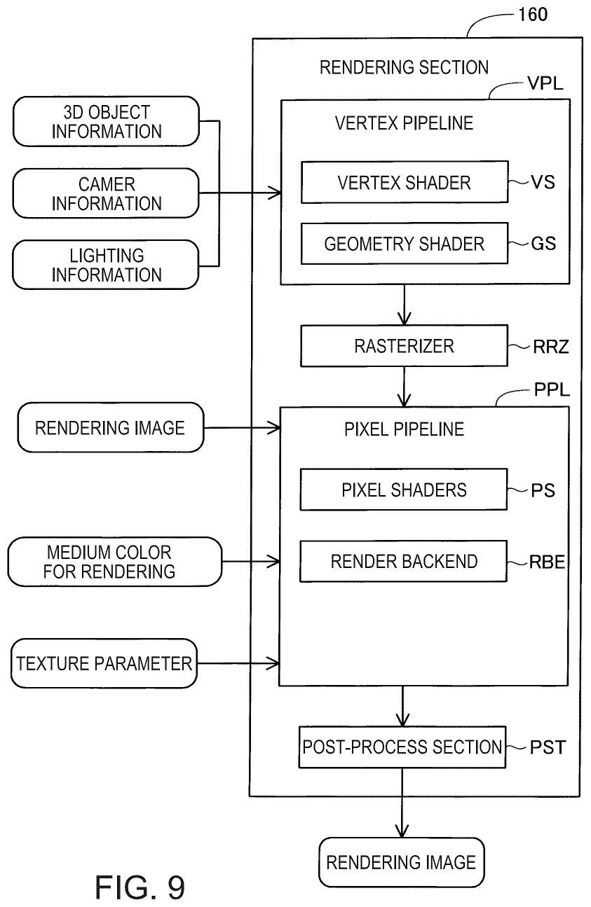

FIG. 9 is an explanatory diagram showing a configuration of the rendering section 160. The rendering section 160 employs a pipeline configuration including a vertex pipeline VPL, a rasterizer RRZ, a pixel pipeline PPL, and a post-process section. The vertex pipeline VPL comprises a vertex shader VS and a geometry shader GS. The pixel pipeline PPL comprises a pixel shader PS and a render backend RBE.

The vertex shader VS uses the 3D object information, camera information, and lighting information to execute processing related to polygons constituting the 3D object. This processing includes coordinate conversion of the vertices of each polygon constituting the 3D object, calculation of normal line vectors of each polygon, shading processing, calculation of texture-mapping coordinates (UV coordinates), and the like. The coordinate conversion includes model conversion, which is the coordinate conversion from the local coordinate system of the 3D object to the world coordinate system, view conversion, which is the coordinate conversion from the world coordinate system to the view coordinate system, and projective conversion, which is the coordinate conversion from the view coordinate system to the screen coordinate system. Some of the coordinate conversions described above may be performed by the geometry shader GS. The processing result of the vertex shader VS is sent to the geometry shader GS.

The geometry shader GS processes a set of vertices of the 3D object. The geometry shader GS can convert polygons into points and lines by increasing or decreasing the number of vertices and can convert points or lines into polygons. The processing result of the geometry shader GS is sent to the rasterizer RRZ. The geometry shader GS may not be provided in the rendering section 160. In this case, the processing result of the vertex shader VS is sent to the rasterizer RRZ.

The rasterizer RRZ generates drawing information for each pixel from the processing result of the vertex pipeline VPL by executing rasterization processing. The processing result of the rasterizer RRZ is sent to the pixel shader PS.

The pixel shader PS performs a lighting process using the rasterized 3D object, the image data, and the texture parameter to calculate the color of the front side polygon and the rear side polygon corresponding to each pixel. As a function for calculating reflection of light in the lighting processing, for example, Disney-principled bidirectional reflectance distribution function (BRDF) can be used. The processing result of the pixel shader PS is sent to the render backend RBE.

The render backend RBE determines whether to write the pixel data generated by the pixel shader PS to the display region of the memory 101. If the render backend RBE judges to write to memory 101, the pixel data is stored as a render target, and if the render backend RBE does not judge to write to memory 101, the pixel data is not stored as a render target. For example, an alpha test, a depth test, a stencil test, or the like is used to determine whether or not to write. In the present embodiment, the pixel data includes color information of the front side polygon and color information of the rear side polygon. The render backend RBE writes the colors of the polygon objects in order from those farthest from the camera to the nearest, for example, by using a depth sorting method. When the render backend RBE writes the color of the polygon on the front side after writing the color of the polygon object on the back side, the render backend RBE synthesizes the color of the polygon object on the back side and the color of the polygon on the front side in accordance with the transmittance of the polygon on the front side by, for example, alpha blending. If the transmittance is zero, when the color of the polygon on the front side is written, the color of the polygon on the rear side is overwritten with the color of the polygon on the front side. Such a process of writing to the display region is also referred to as a “drawing process”. When the pixel data is written into memory 101, the pipeline processing is completed.

The post-process section PST performs post-processing such as anti-aliasing, ambient occlusion, screen space reflection, and processing of depth of field on the rendering image formed of the pixel data stored in memory 101. The post-processing can improve the appearance of the rendering image.

The update reception section 165 receives an instruction to update display of a rendering image representing a printed matter represented as a 3D object in the virtual space. To be specific, the update reception section 165 receives a change instruction to change the appearance of the 3D object indicated by the touch operation for the rendering image, as the preview image, displayed in the display region FV2 on the user interface UI (see FIG. 5). The update reception section 165 outputs the received change instruction to the rendering section 160. The update reception section 165 is also referred to as a “change reception section”.

The print data generating section 170 generates print data to be supplied to the printing device 400. The print data generating section 170 includes a setting section 171, a separation printing section 173, and a halftone processing section 175.

The setting section 171 determines whether or not the horizontal inversion process of the image to be printed is necessary according to the printing condition. More specifically, when “rear side printing” is selected as the type of printing, the setting section 171 determines that the image to be printed needs to be subjected to the horizontal inversion process. In a case where “front side printing” is selected as the type of printing, the setting section 171 determines that the horizontal inversion process is not necessary for the image to be printed.

When the horizontal inversion process is necessary, that is, when rear side printing is designated, the setting section 171 executes the horizontal inversion process of the device color image data IMd obtained by the color conversion process of CMS 151. On the other hand, when front side printing is designated, the inversion processing is not executed.

In a case where a plurality of print layers are formed, the setting section 171 determines the order of stacking the print layers. Specifically, the arrangement position (arrangement side surface) at which the print layers are arranged with respect to the print medium and the layering order in which the plurality of print layers is stacked in a case where the number of print layers is plural are determined according to the printing condition.

The separation printing section 173 converts the output value of each pixel of the device color image data IMd that was subjected to horizontal inversion processing or that was not subjected to horizontal inversion processing, into a density value of a plurality of color materials of the printing device 400. In the present embodiment, the separation printing section 173 converts the output value CMYK of each pixel of the device color image data IMd into a density value of each color of the process ink. Each version of CMYKLcLm is generated by the processing of the separation printing section 173. When printing is performed on both sides of the print medium PM, the separation printing section 173 generates each of CMYKLcLm plates for the front side and rear side of the print medium PM.

The halftone processing section 175 generates print data by performing a halftone process using the density value of each pixel after the separation process. The printing device 400 receives the print data sent from the halftone processing section 175, and executes printing based on the printing conditions included in the received print data. In a case where printing is performed on both sides of the print medium PM, the halftone processing section 175 generates print data for each of the front side and the rear side of the print medium PM.

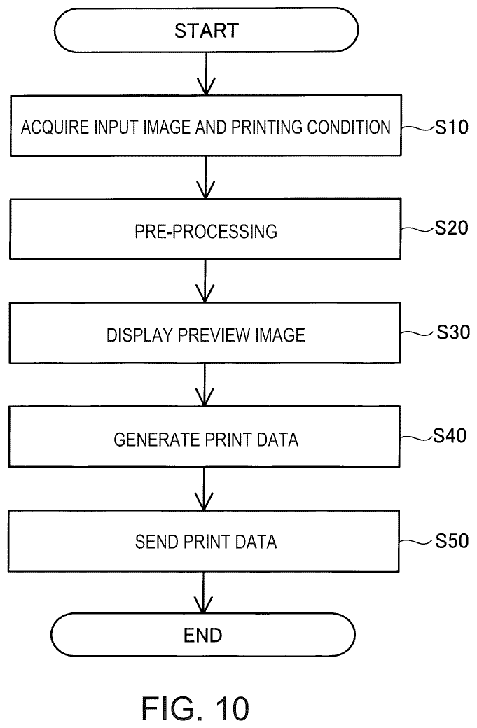

FIG. 10 is a flowchart showing a process related to printing executed in the image processing device 100. The process in FIG. 10 is started, for example, when user's operation instruction is received via the input device 200.

In step S10, input image data IMi and printing conditions are acquired. Specifically, first, a user interface UI (see FIG. 5) is displayed on the display device 300. The image data (the input image data IMi) designated by user input via user interface UI is acquired. The information indicating printing conditions input by the user via the user interface UI is acquired. The printing condition includes a condition representing a side on which the color layer is superimposed among the front side and the rear side of the print medium PM.

In step S20, pre-processing is executed by each section of the pre-process section 150. The content of the pre-processing is as shown in FIG. 9. By the pre-processing, the device color image data IMd, the rendering image data IMm, and the rendering medium color Clp are generated. The device color image data IMd is transmitted to the print data generating section 170. The rendering image data IMm and the rendering medium color Clp are transmitted to the rendering section 160.

In step S30, the rendering image generated by the rendering section 160 is displayed on the display device 300 as the preview image. The processing of the rendering section 160 is as shown in FIG. 9. In step S40, the print data generating section 170 generates print data. In step S50, the print data is transmitted to the printing device 400. The above described processing is a series of processes relating to printing executed in the image processing device 100.

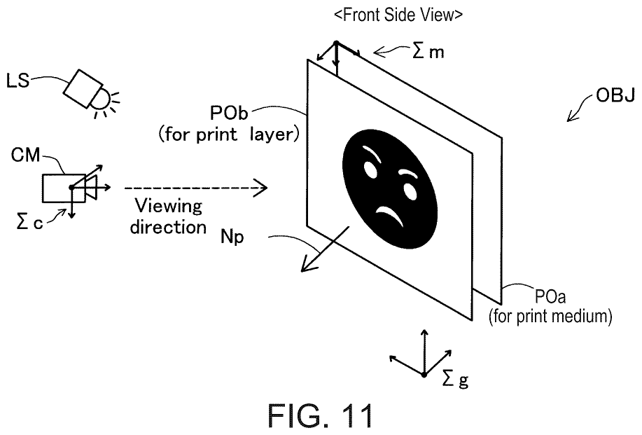

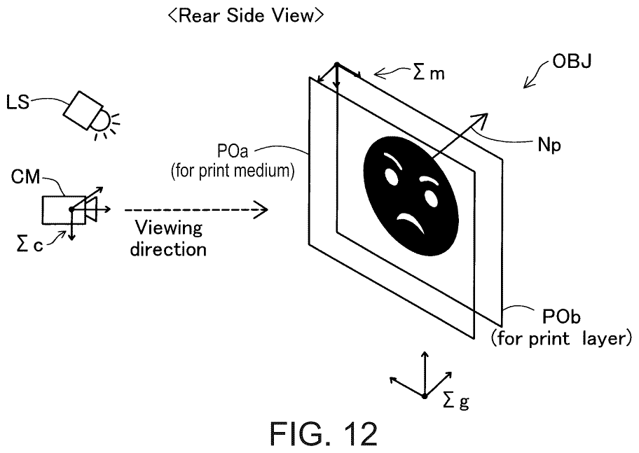

In the present embodiment, the image processing device 100 displays the rendering image as the preview image. FIG. 11 is an explanatory diagram schematically showing a state in which the front side of a printed matter represented as a 3D object in the virtual space is observed. FIG. 12 is an explanatory diagram schematically illustrating a state in which the rear side of the printed matter represented as a 3D object in the virtual space is observed. Here, as shown in FIG. 2, an example of printed matter printed on the front side of the print medium PM by front side printing is shown. The printed matter is represented as a 3-Dimensional Object (3D object) OBJ. The 3D object OBJ includes a polygon object POa for rendering the print medium PM and a polygon object POb for rendering the print layers.

Two polygon objects POa and POb are arranged in parallel. The direction of the normal line vector Np of the polygon object POa is toward the front side of the 3D object OBJ. The 3D object OBJ is illuminated by the light source LS. In FIGS. 11 and 12, the line of sight of the camera CM is indicated by a dashed arrow. In the rendering process, the 3D object OBJ is treated as a transparent object. In FIGS. 11 and 12, for the sake of convenience, the distance between the two polygon objects POa and POb is depicted to be large, but in actuality, in the virtual space, the distance between polygon objects POa and POb is a very short distance to the extent that Z-fighting does not occur. In the virtual space, the thickness of the polygon object POa representing the print medium PM reflects the thickness of the print medium PM, and the thickness of the polygon object POb representing the print layers is substantially zero.

In FIGS. 11 and 12, coordinate systems used for the rendering process are depicted, including the local coordinate system Σm (also referred to as a model coordinate system), which is a three-dimensional orthogonal coordinate system of the 3D object OBJ, the world coordinate system Σg (also referred to as a global coordinate system), which is a three-dimensional orthogonal coordinate system of the virtual space, and the view coordinate system Ec (also referred to as a camera coordinate system), which is a three-dimensional orthogonal coordinate system of the camera CM arranged in the virtual space. In the rendering process, another coordinate system such as a screen coordinate system, which is the coordinate system of a screen onto which a scene viewed from camera CM is projected, is also used, but is omitted in FIGS. 11 and 12.

As shown in FIG. 11, when the viewing direction of the camera CM is directed to the front side of the 3D object OBJ, a front side view of the front side of the 3D object OBJ observed through the camera CM is generated as a rendering image.

As shown in FIG. 12, in a state where the rear side of the 3D object OBJ is directed in the viewing direction of the camera CM, a rear side view in which the rear side of the 3D object OBJ is observed through the camera CM is generated as a rendering image.

Each of the polygon objects POa and POb may be formed of one polygon. Alternatively, each of the polygon objects POa and POb may consist of multiple smaller polygons. If the polygon object is composed of a plurality of polygons, it is possible to easily generate not only the rendering image of a flat printed matter but also the rendering image of a curved printed matter.

The image processing device 100 according to the present embodiment can change the posture of the 3D object representing the printed matter in the virtual space in response to an operation instruction from the user and can display a preview image representing the changed printed matter on the display device 300. As described above, the display device 300 has a function as a pointing device. The user can give an instruction to switch the display of the preview image by performing a touch operation on the image displayed on the display device 300.

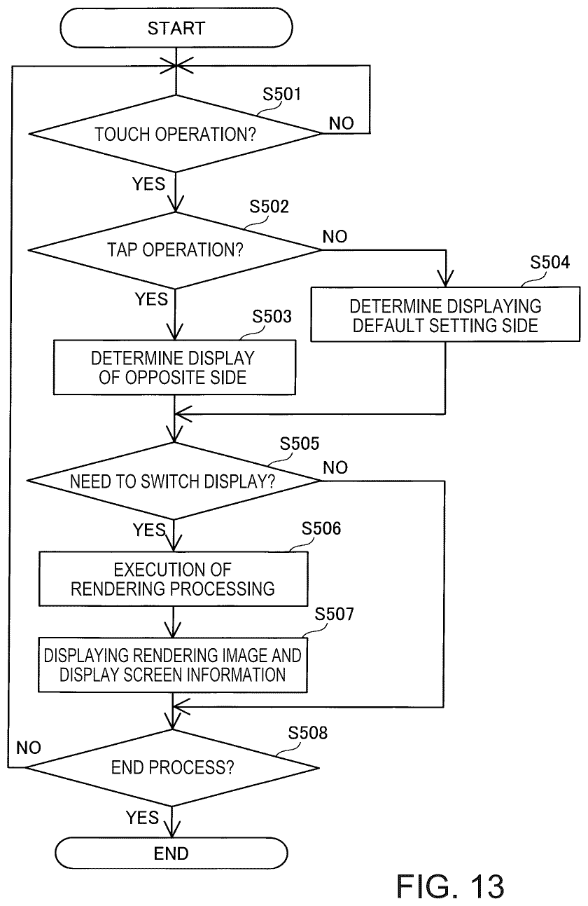

FIG. 13 is a flowchart showing a switching process of a preview image display. The processing illustrated in FIG. 13 is executed by the processor 103 that functions as the rendering section 160 and the update reception section 165. It is assumed that the first preview image is displayed in the display region FV2 of the user interface UI at the time when the process shown in FIG. 13 is started. In step S501, it is determined whether or not a touch operation for instructing display switching has been performed. The touch operation for instructing the display switching is an operation of tapping or double-tapping the preview image displayed in the display region FV2 of the user interface UI shown in FIG. 6. For the sake of convenience, the following description assumes only a tap operation on the display region FV2 or a double tap operation on the display region FV2 as a touch operation. When there is a touch operation (step S501; YES), the process of step S502 is executed. In step S502, it is determined whether or not the touch operation is a tap. In the case of the operation of tapping the preview image (step S502; YES), the process of step S503 is executed. In step S502, when the touch operation is an operation of double-tapping the preview image (step S502; NO), the process of step S504 is executed. The tap on the preview image is an operation of instructing to display the side opposite to the current display surface. The double tap on the preview image is an operation of instructing to display an initial setting side. The initial setting side is, for example, a front side.

In step S503, it is determined to display the side opposite to the currently displayed side. When the currently displayed side is the front side, it is determined to execute display switching to display the rear side. When the currently displayed side is the rear side, it is determined to execute display switching to display the front side.

In step S504, it is decided to display a default side.

In step S505, it is determined whether display switching is necessary. In step S503, when it is determined to display the surface opposite to the currently displayed surface, it is determined that display switching is necessary. In step S504, it is determined to display the initially set side, and if the currently displayed side is the rear side, it is determined to execute display switching to display the front side. In step S504, it is determined that the initially set side is to be displayed, and it is determined that display switching is not to be executed if the currently displayed side is the front side.

When display switching is required (step S505; YES), the processing of step S506 is executed. When the display switching is not required (step S505; NO), the process of step S508 is executed.

In step S506, the rendering process is performed anew to generate a new rendering image. When the displayed side is the front side and the display switching is required, the position where each 3D object is arranged is changed so that the rear side is displayed. As a result, a rendering image in which the rear side of the printed matter faces the front is generated. When the displayed side is the rear side and display switching is required, the position where each 3D object is arranged is changed so that the front side is displayed. As a result, a rendering image in which the front side of the printed matter faces the front is generated.

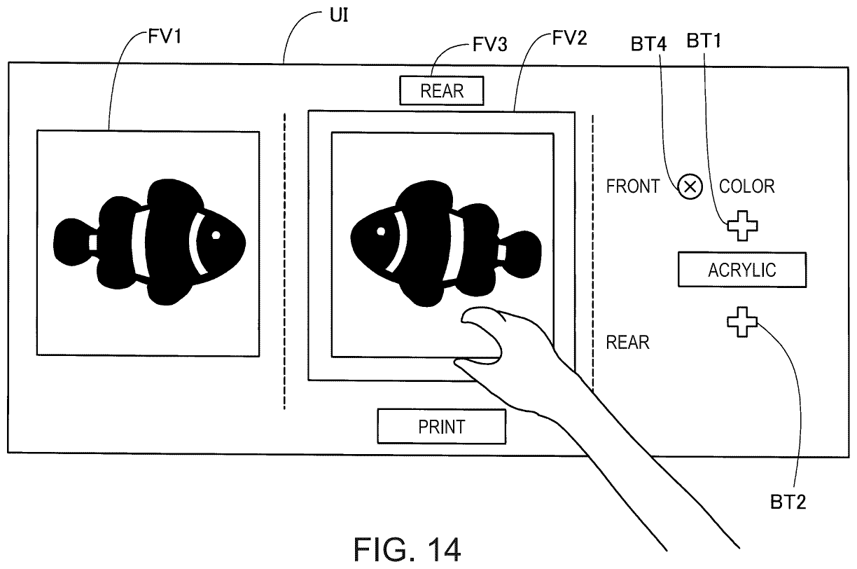

FIG. 14 is an explanatory diagram illustrating a state in which the image processing device 100 displays a rendering image again in response to a touch operation. In step S507, the newly generated rendering image is displayed as a preview image in the display region FV2 of the user interface UI. The display screen information is displayed in the display region FV3. When the new display surface is the front side, “front side” is displayed in the display region FV3 as the display screen information. When the new display surface is the rear side, “rear side” is displayed in the display region FV3 as the display screen information. For example, when an operation of tapping the preview image displayed in the display region FV2 shown in FIG. 6 is performed, the display side is switched as shown in FIG. 14. Therefore, the user can easily recognize which side of the virtual three dimensional object representing the printed matter is being displayed. The display screen information is also referred to as “display information”. The display information indicates the appearance of the 3D object represented by the currently displayed preview image.

In step S508, it is determined whether or not to end the process. For example, in a case where the print button BTP is pressed in the user interface UI, it is determined that the process is ended. If it is determined that the process is to be terminated (step S508; YES), the process shown in FIG. 13 is terminated. When it is determined that the process is to be continued (step S508; NO), the process of step S501 is executed again. The processes from step S501 to step S508 are repeatedly executed until the print button BTP is pressed.

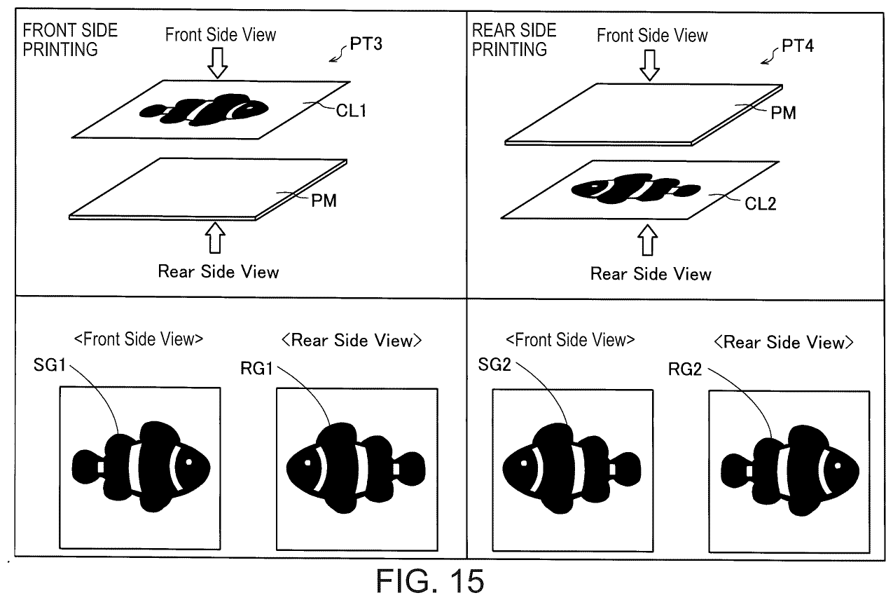

FIG. 15 is an explanatory view of the effect of the present embodiment. In the upper left frame, printed matter PT3 in which the print medium PM and the color layer CL1 are superimposed by front side printing is shown. In the lower left frame, preview images of the front side and the rear side of the printed matter PT3 are shown. In the upper right frame, a printed matter PT4 is shown in which the print medium PM and the color layer CL2 are superimposed in the rear side printing. In the lower right frame, preview images of the front side and the rear side of the printed matter PT4 are shown. As shown in FIG. 15, the front side image SG1 representing the front side of the printed matter PT3 in the case of front side printing and the rear side image RG2 representing the rear side of the printed matter PT4 in the case of rear side printing have the same appearance. Furthermore, the rear side image RG1, which represents the rear side of the printed matter PT3 in the case of front side printing, and the front side image SG2, which represents the front side of the printed matter PT4 in the case of rear side printing, are both observed through the transparent print medium PM. The images have the same appearance. By this, while the display of the previewing screen of the front side and the previewing screen of the rear side is repeatedly switched, it is assumed that it is difficult for the user to grasp which of the front side and the rear side is the currently displayed screen with only one virtual 3D display of the printed matter.

However, in the present embodiment, the display screen information, which indicates the appearance of the 3D object representing the printed matter and shows whether it is on the front side or the rear side, is displayed together with the preview image in the display region FV3. Therefore, the user can easily grasp whether the currently displayed screen is the front side or the rear side. Further, the user can easily change the appearance of the virtual three dimensional object representing the printed matter by a simple operation. Therefore, the operability of the user can be improved.

### B. Alternative Embodiments

### B1. First Alternative Embodiment

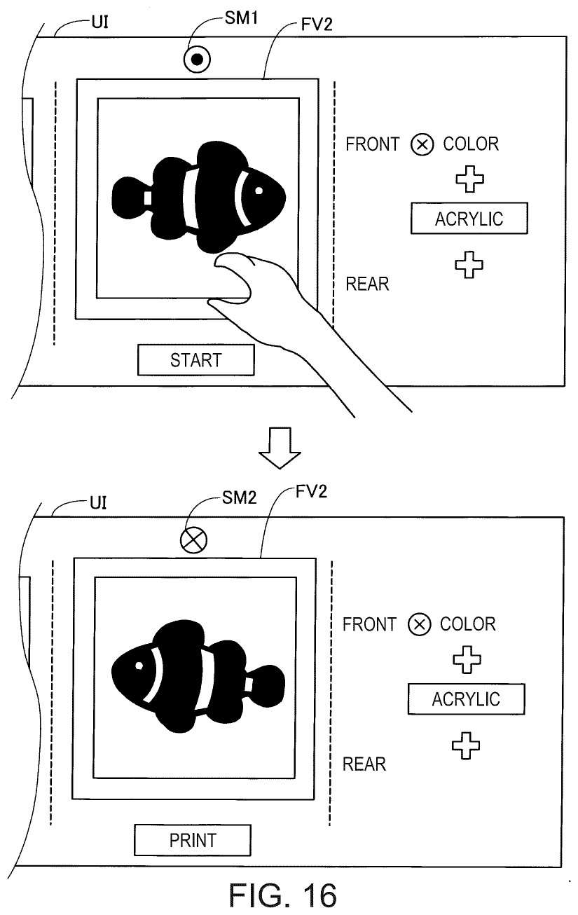

In the above-described embodiment, the aspect in which the character information indicating the front side and the rear side of the printed matter is displayed has been described. Alternatively, information indicating the front side and the rear side of the printed matter may be represented by icons. FIG. 16 is an explanatory diagram of a mode of displaying display information according to the first alternative embodiment.

The upper section of FIG. 16 illustrates an example of the user interface UI in which the preview image of the front side of the printed matter is displayed. At the upper section of the preview image, an icon SM1 is displayed, indicating that the front side is being displayed. A lower section of FIG. 16 illustrates an example of the user interface UI in which the preview image of the rear side of the printed matter is displayed. Here, it is assumed that there is a virtual arrow vertically penetrating a plane parallel to the front side and the rear side of the print medium. The direction of this arrow is from the rear side to the front side of the printed matter. In the upper section of FIG. 16, the icon SM1 represents the shape of the arrow as viewed from the front of the arrow, and indicates the direction of the virtual arrow. In the lower section of FIG. 16, the icon SM2 represents the shape of the arrow as viewed from the rear of the arrow, and represents the direction of the virtual arrow. The icon SM1 is also referred to as an “icon for the front side”. The icon SM2 is also referred to as an “icon for the rear side”. Since the display information indicating the appearance of the virtual three dimensional object representing the printed matter is displayed, the user can easily grasp the appearance of the currently displayed three dimensional object.

### B2. Second Alternative Embodiment

In the above-described embodiment, an example in which either the front side or the rear side of the printed matter is displayed as the preview image on the user interface UI has been described. Alternatively, in the display region FV2 of the user interface UI, the user may be able to freely change the posture of the virtual 3D object representing the printed matter. Therefore, the operability of the user can be improved.

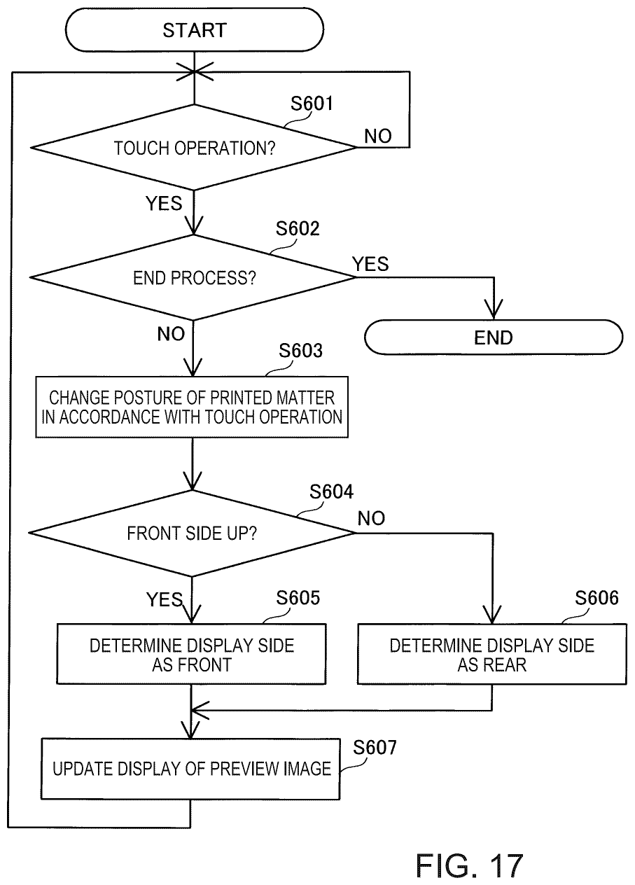

FIG. 17 is a flowchart illustrating an example of preview image display switching processing according to the second alternative embodiment. It is assumed that the first preview image is displayed in the display region FV2 of the user interface UI at the time when the process shown in FIG. 17 is started. In step S601, it is determined whether or not a touch operation has been performed on the preview image displayed in the display region FV2 of the user interface UI. When there was a touch operation (step S601; YES), the process of step S602 is executed. In step S602, it is determined whether or not to end the process.

For example, in a case where the touch operation detected in step S601 is an operation of pressing the print button BTP on the user interface UI, it is determined that the process is ended. If it is determined that the process is to be terminated (step S602; YES), the process shown in FIG. 17 is terminated. When it is determined that the process is not to be ended (step S602; NO), the process of step S603 is executed.

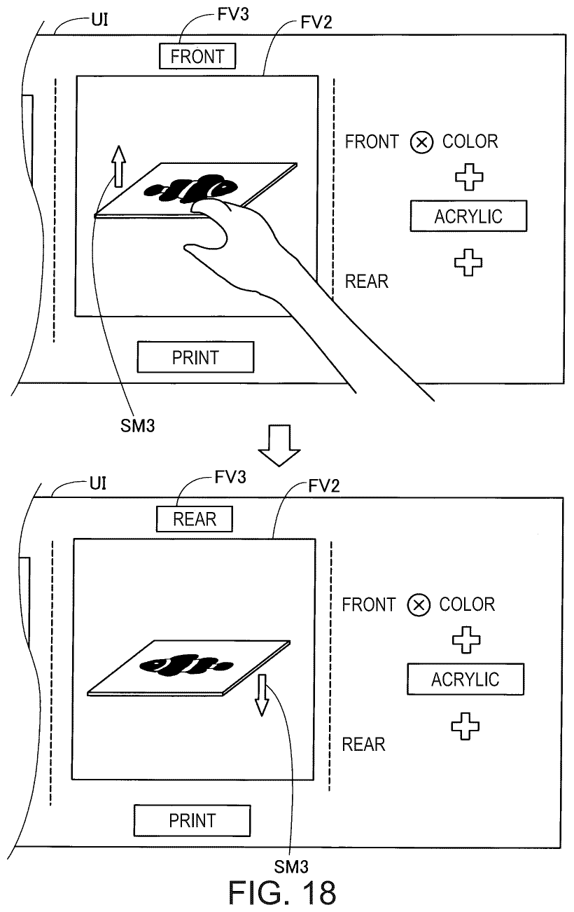

FIG. 18 is an explanatory diagram showing an example of a display mode of a preview image according to a second alternative embodiment. As shown in FIG. 18, the arrow SM3 is displayed in the display region FV2 together with the preview image of the printed matter. The arrow SM3 is a 3D object representing an arrow that vertically penetrates a plane parallel to the front and rear sides of the printed material and extends from the rear side to the front side of the printed matter. An arrow SM3 indicates a direction in which the front side of the 3D object representing the front side of the print medium PM. Therefore, the user can easily grasp the direction of the printed matter. The arrow SM3 is also referred to as an “icon”. Further, the display screen information representing the display side of the printed matter is displayed in the display region FV3.

In step S603 shown in FIG. 17, the posture of the virtual 3D object representing the printed matter is changed in accordance with the touch operation detected in step S601. Further, the posture of the 3D object representing the arrow SM3 is changed in accordance with the posture of the virtual 3D object representing the printed matter.

In step S604, it is determined whether or not the front side of the printed matter after the posture is changed is directed to the viewing direction of the virtual camera. When the front side of the printed matter after the posture is changed is directed to the viewing direction of the virtual camera (step S604; YES), the display side is determined to be “front side” in step S605. When the front side of the printed matter after the posture is changed is not directed to the viewing direction of the virtual camera, that is, when the rear side of the printed matter after the posture is changed is directed to the viewing direction of the virtual camera (step S604; NO), the display surface is determined to be “rear” in step S606.

In step S607, the display of the preview image is updated. To be specific, a preview image representing a virtual 3D object representing the printed matter whose posture has been changed in step S603 is displayed in the display region FV2. Further, the display screen information indicating the display side determined in step S605 or step S606 is displayed in the display region FV3. Thereafter, the process of step S601 is executed again.

Further, the user may give an instruction to switch between displaying and not displaying the arrow SM3 by a predetermined touch operation. The predetermined touch operation is to tap a region around the arrow SM3 or a virtual 3D object representing a printed matter. This operation instruction is also referred to as a “switching instruction”. In a case where the arrow SM3 is displayed, when the operation instruction is received, the rendering section 160 hides the arrow SM3. When the arrow SM3 is not displayed, the user may give an instruction to display the arrow SM3 by tapping a region around the virtual 3D object representing the printed matter. If this operation instruction is received when the arrow SM3 is not displayed, the rendering section 160 displays the arrow SM3. Since the display information indicating the appearance of the virtual three dimensional object representing the printed matter is displayed, the user can easily grasp the appearance of the currently displayed three dimensional object. Since the user can appropriately select displaying or not displaying the arrow SM3 indicating the posture of the virtual printed matter, usability is improved. In addition, since displaying or not displaying the arrow SM3 can be switched by the touch operation, the operability of the user can be improved.

Further, the character information indicating the front side or the rear side as shown in FIG. 18 may not be displayed. In this case, when the posture of the 3D object representing the print medium PM in the virtual space indicates that the viewing direction of the virtual camera is perpendicular to the front side of the 3D object, an icon as shown in FIG. 16 may be displayed. When the front side of the printed matter is displayed as the preview image, the icon SM1 as shown in the upper section of FIG. 16 may be displayed. When the front side of the printed matter is displayed as the preview image, the icon SM2 as shown in the lower section of FIG. 16 may be displayed.

Alternatively, when the posture of the 3D object representing the print medium PM in the virtual space is such that the viewing direction of the virtual camera is perpendicular to the front side of the 3D object, the icon SM1 or the icon SM2 may be hidden without receiving an instruction to hide the icon SM1 or the icon SM2. The arrow SM3 may be displayed again when the orientation of the 3D object representing the print medium PM is changed by the user's operation and the viewing direction of the virtual camera is no longer perpendicular to the front side of the 3D object.

### B3. Third Alternative Embodiment

In the above-described embodiment, the preview image is displayed in such a manner that the posture of the 3D object representing the printed matter in the virtual space is changed. The preview image may be displayed in a mode in which the viewpoint position and the viewing direction of a virtual camera with respect to the 3D object representing the printed matter in the virtual space are changed.

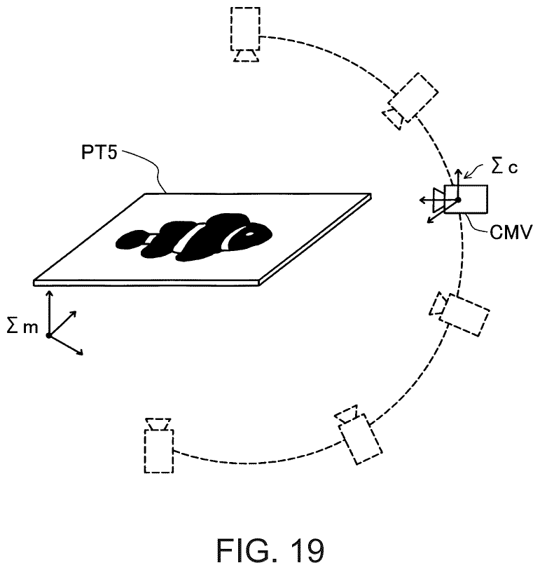

FIG. 19 is an explanatory diagram showing a positional relationship between a virtual object representing a printed matter and the camera placed in a virtual space. The camera CMV arranged in the virtual space is always directed to the center of the object representing the printed matter PT5. When the camera CMV moves around the object representing the printed matter PT5, the viewpoint position and the viewing direction of the camera CMV change. The preview image is displayed in a mode in which the viewpoint position and the viewing direction of the camera CMV are changed. Therefore, the user can see the 3D object representing the printed matter in the virtual space at the viewpoint position and the viewing direction of the camera CMV moving around the object representing the printed matter PT5.

Further, in order to represent the viewpoint position and the viewing direction of the camera CMV arranged in the virtual space, an icon imitating the shape of the virtual camera CMV may be displayed in the display region FV2 of the user interface UI together with the object representing the printed matter PT5. The icon imitating the shape of the virtual camera CMV represents the viewpoint position and the viewing direction of the camera CMV arranged in the virtual space. An icon imitating the shape of a human eye may be displayed in the display region FV2 of the user interface UI together with the object representing the printed matter PT5. The icon imitating the shape of a human eye represents the viewpoint position and the viewing direction of the camera CMV arranged in the virtual space. Since the display information indicating the appearance of the virtual three dimensional object representing the printed matter is displayed, the user can easily grasp the appearance of the currently displayed three dimensional object. As in the second alternative embodiment, the user may be able to select displaying or not displaying an icon imitating the shape of the virtual camera CMV or an icon imitating the shape of a human eye by a predetermined touch operation. Since the user can appropriately select displaying or not displaying the icon representing the viewpoint position and the viewing direction of the virtual camera, usability is improved.

Further, when the orientation of the 3D object representing the print medium PM in the virtual space is such that the viewing direction of the virtual camera is perpendicular to the front side of the 3D object, the icons may be hidden without receiving the instruction to hide the icons. The icon may be displayed again when the posture of the 3D object representing the print medium PM is changed by the user's operation and the viewing direction of the virtual camera is no longer perpendicular to the front side of the 3D object.

### B4. Fourth Alternative Embodiment

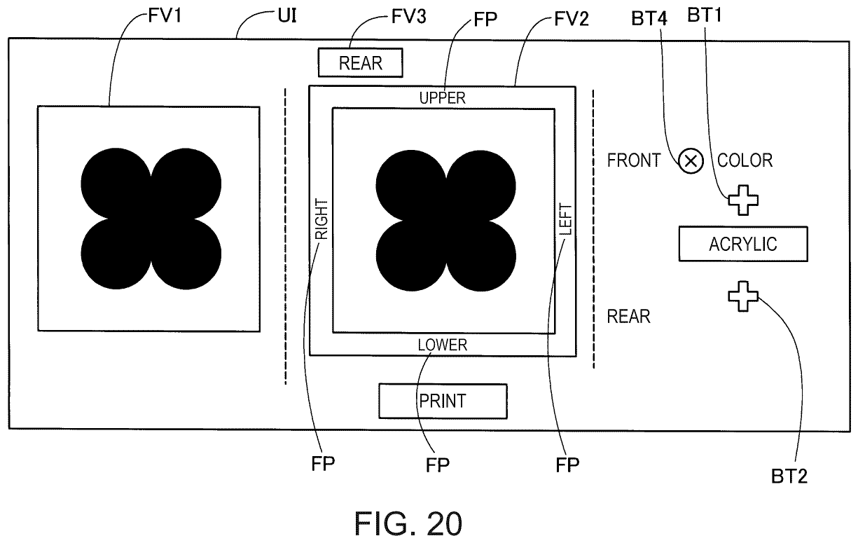

FIG. 20 is an explanatory diagram of a user interface UI according to a fourth alternative embodiment. In the display region FV2 of the user interface UI, when the user can freely change the posture of the virtual 3D object representing the printed matter, the following problem may occur. In the example shown in FIG. 20, the image represented by the input image data IMi is bilaterally symmetric and vertically symmetric. In the case of such an image, it may be difficult for the user to grasp the vertical and horizontal positions of the image represented by the input image data IMi in the currently displayed preview image.

Therefore, in the illustrated example, the location information FP indicating each of the upper, lower, left, and right sides of the front side of the input image data IMi is displayed together with the preview image. As a result, the user can easily grasp the vertical and horizontal positions of the image represented by the input image data IMi in the currently displayed preview image.

### C. Other Embodiments

The present disclosure is not limited to the above described embodiments and can be realized by various configurations without departing from the scope of the present disclosure. For example, the technical features in the embodiments corresponding to the technical features in the aspects described in the summary of the disclosure can be replaced or combined as appropriate in order to solve some or all of the problems described above or in order to achieve some or all of the effects described above. If the technical features are not described as essential in this specification, the technical features can be appropriately omitted.

(1) According to a first aspect of the present disclosure, an image processing method is provided. The image processing method includes a step (a) of receiving a layering order of one or more print layers, which are to be layered on a print medium by printing on the print medium, and the print medium; a step (b) of displaying, on a display device, a preview image representing a virtual three dimensional object of printed matter in which the one or more print layers and the print medium are superimposed and combined in the layering order, the preview image corresponding to an appearance in a three dimensional virtual space; a step (c) of receiving a change instruction to change the appearance of the three dimensional object; a step (d) of changing, so that the appearance of the three dimensional object is changed in accordance with the change instruction, at least one of a posture of the three dimensional object in the virtual space, or a viewpoint position and a viewing direction of a virtual camera with respect to the three dimensional object in the virtual space, and of displaying, on the display device, the preview image representing the three dimensional object after changing; and a step (e) of displaying, on the display device together with the preview image, display information indicating appearance of the three dimensional object represented by the currently displayed preview image.

In the above aspect, it is possible to easily change the appearance of the virtual three dimensional object representing the printed matter. Since the display information indicating the appearance of the virtual three dimensional object representing the printed matter is displayed, the user can easily grasp the appearance of the three dimensional object currently displayed. Therefore, the operability of the user can be improved.

(2) In the image processing method of the above aspect, in step (e), character information may be displayed as the display information, the character information indicating which of the front side and the rear side of the three dimensional object is displayed. According to the above aspect, the user can easily recognize which side of the virtual three dimensional object representing the printed matter is displayed.

(3) In the image processing method of the above aspect, in step (e), an icon may be displayed as the display information, the icon being an image displayed together with the three dimensional object and indicating a direction in which a front side of the three dimensional object faces.

(4) In the image processing method of the above aspect, in step (e), an icon may be displayed as the display information, the icon indicating the viewpoint position and the viewing direction of the virtual camera with respect to the three dimensional object.

(5) In the image processing method of the above aspect, the image processing method may further include a step (f) of receiving a switching instruction for switching between displaying and not displaying the icon and a step (g) of displaying the icon or not displaying the icon in response to the switching instruction.

According to the above aspect, the user can select displaying or not displaying the icon as the display information, and thus it is possible to improve the operability of the user.

(6) In the image processing method of the above aspect, the image processing method may further include a step (h) of not displaying the icon without receiving an instruction to not display the icon when the front side or the rear side of the three dimensional object faces the front or when the viewing direction of the virtual camera is perpendicular to the front side or to the rear side of the three dimensional object.

(7) In the image processing method of the above aspect, the image processing method may further include a step (i) of displaying an icon for the front side as the display information when the front side of the three dimensional object is displayed, and displaying an icon for the rear side as the display information when the rear side of the three dimensional object is displayed, in a case where the front side or the rear side of the three dimensional object faces the front side, or in a case where the viewing direction of the virtual camera is perpendicular to the front side or the rear side of the three dimensional object.

(8) According to a second aspect of the present disclosure, an image processing device is provided. The image processing device includes a print setting reception section that receives a layering order of one or more print layers, which are to be layered on a print medium by printing on the print medium, and the print medium; a display processing section configured to display, on a display device, a preview image representing a virtual three dimensional object of printed matter in which the one or more print layers and the print medium are superimposed and combined in the layering order, the preview image corresponding to an appearance in a three dimensional virtual space; and a change reception section configured to receive a change instruction to change the appearance of the three dimensional object, wherein the display processing section when the change reception section receives the change instruction, changes at least one of a posture of the three dimensional object in the virtual space, or a viewpoint position and a viewing direction of a virtual camera with respect to the three dimensional object in the virtual space, so that the appearance of the three dimensional object is changed in accordance with the change instruction and displays, on the display device, the preview image representing the three dimensional object after changing, and the display information indicating appearance of the three dimensional object represented by the preview image after changing.

In the above aspect, it is possible to easily change the appearance of the virtual three dimensional object representing the printed matter. Since the display information indicating the appearance of the virtual three dimensional object representing the printed matter is displayed, the user can easily grasp the appearance of the three dimensional object currently displayed. Therefore, the operability of the user can be improved.

(9) According to a third aspect of the present disclosure, a printing system is provided. The printing system includes an image processing device, a printing device, and a display device. The image processing device includes a print setting reception section that receives a layering order of one or more print layers, which are to be layered on a print medium by printing on the print medium, and the print medium; a display processing section configured to display, on the display device, a preview image representing a virtual three dimensional object of printed matter in which the one or more print layers and the print medium are superimposed and combined in the layering order, the preview image corresponding to an appearance in a three dimensional virtual space; and a change reception section configured to receive a change instruction to change the appearance of the three dimensional object, wherein the display processing section when the change reception section receives the change instruction, changes at least one of a posture of the three dimensional object in the virtual space, or a viewpoint position and a viewing direction of a virtual camera with respect to the three dimensional object in the virtual space, so that the appearance of the three dimensional object is changed in accordance with the change instruction and displays, on the display device, the preview image representing the three dimensional object after changing, and the display information indicating appearance of the three dimensional object represented by the preview image after changing.

In the above aspect, it is possible to easily change the appearance of the virtual three dimensional object representing the printed matter. Since the display information indicating the appearance of the virtual three dimensional object representing the printed matter is displayed, the user can easily grasp the appearance of the three dimensional object currently displayed. Therefore, the operability of the user can be improved.

(10) According to a fourth aspect of the present disclosure, a non-transitory computer-readable storage medium storing an image processing program is provided. The non-transitory computer-readable storage medium storing an image processing program includes a function (a) of receiving a layering order of one or more print layers, which are to be layered on a print medium by printing on the print medium, and the print medium; a function (b) of displaying, on a display device, a preview image representing a virtual three dimensional object of printed matter in which the one or more print layers and the print medium are superimposed and combined in the layering order, the preview image corresponding to an appearance in a three dimensional virtual space; a function (c) of receiving a change instruction to change the appearance of the three dimensional object; a function (d) of changing, so that the appearance of the three dimensional object is changed in accordance with the change instruction, at least one of a posture of the three dimensional object in the virtual space, or a viewpoint position and a viewing direction of a virtual camera with respect to the three dimensional object in the virtual space, and of displaying, on the display device, the preview image representing the three dimensional object after changing; and a function (e) of displaying, on the display device together with the preview image, display information indicating appearance of the three dimensional object represented by the currently displayed preview image.

In the above aspect, it is possible to easily change the appearance of the virtual three dimensional object representing the printed matter. Since the display information indicating the appearance of the virtual three dimensional object representing the printed matter is displayed, the user can easily grasp the appearance of the three dimensional object currently displayed. Therefore, the operability of the user can be improved.

What is claimed is:

1. An image processing method comprising:
a step (a) of receiving a layering order of one or more print layers, which are to be layered on a print medium by printing on the print medium, and the print medium;
a step (b) of displaying, on a display device, a preview image representing a virtual three dimensional object of printed matter in which the one or more print layers and the print medium are superimposed and combined in the layering order, the preview image corresponding to an appearance in a three dimensional virtual space;
a step (c) of receiving a change instruction to change the appearance of the three dimensional object;
a step (d) of changing, so that the appearance of the three dimensional object is changed in accordance with the change instruction, at least one of a posture of the three dimensional object in the virtual space, or a viewpoint position and a viewing direction of a virtual camera with respect to the three dimensional object in the virtual space, and of displaying, on the display device, the preview image representing the three dimensional object after changing; and
a step (e) of displaying, on the display device together with the preview image, display information indicating appearance of the three dimensional object represented by the currently displayed preview image.

2. The image processing method according to claim 1, wherein
in step (e), character information is displayed as the display information, the character information indicating which of the front side and the rear side of the three dimensional object is displayed.

3. The image processing method according to claim 1, wherein
in step (e), an icon is displayed as the display information, the icon being an image displayed together with the three dimensional object and indicating a direction in which a front side of the three dimensional object faces.

4. The image processing method according to claim 1, wherein
in step (e), an icon is displayed as the display information, the icon indicating the viewpoint position and the viewing direction of the virtual camera with respect to the three dimensional object.

5. The image processing method according to claim 3, further comprising:
a step (f) of receiving a switching instruction for switching between displaying and not displaying the icon and
a step (g) of displaying the icon or not displaying the icon in response to the switching instruction.

6. The image processing method according to claim 3, further comprising:
a step (h) of not displaying the icon without receiving an instruction to not display the icon when the front side or the rear side of the three dimensional object faces the front or when the viewing direction of the virtual camera is perpendicular to the front side or to the rear side of the three dimensional object.

7. The image processing method according to claim 3, further comprising:
a step (i) of, when the front side or the rear side of the three dimensional object faces the front direction, or when the viewing direction of the virtual camera is perpendicular to the front side or the rear side of the three dimensional object,
displaying an icon for the front side as the display information when a front side of the three dimensional object is displayed and
displaying an icon for the rear side as the display information when a rear side of the three dimensional object is displayed.

8. An image processing device comprising:
a print setting reception section that receives a layering order of one or more print layers, which are to be layered on a print medium by printing on the print medium, and the print medium;
a display processing section configured to display, on a display device, a preview image representing a virtual three dimensional object of printed matter in which the one or more print layers and the print medium are superimposed and combined in the layering order, the preview image corresponding to an appearance in a three dimensional virtual space; and
a change reception section configured to receive a change instruction to change the appearance of the three dimensional object, wherein
the display processing section
when the change reception section receives the change instruction, changes at least one of a posture of the three dimensional object in the virtual space, or a viewpoint position and a viewing direction of a virtual camera with respect to the three dimensional object in the virtual space, so that the appearance of the three dimensional object is changed in accordance with the change instruction and
displays, on the display device, the preview image representing the three dimensional object after changing, and the display information indicating appearance of the three dimensional object represented by the preview image after changing.

9. A printing system comprising:
an image processing device;
a printing device; and
a display device, wherein
the image processing device includes
a print setting reception section that receives a layering order of one or more print layers, which are to be layered on a print medium by printing on the print medium, and the print medium,
a display processing section configured to display, on the display device, a preview image representing a virtual three dimensional object of printed matter in which the one or more print layers and the print medium are superimposed and combined in the layering order, the preview image corresponding to an appearance in a three dimensional virtual space; and
a change reception section configured to receive a change instruction to change the appearance of the three dimensional object, and
the display processing section
when the change reception section receives the change instruction, changes at least one of a posture of the three dimensional object in the virtual space, or a viewpoint position and a viewing direction of a virtual camera with respect to the three dimensional object in the virtual space, so that the appearance of the three dimensional object is changed in accordance with the change instruction and
displays, on the display device, the preview image representing the three dimensional object after changing, and the display information indicating appearance of the three dimensional object represented by the preview image after changing.

10. A non-transitory computer-readable storage medium storing a program, the program comprising:
a function (a) of receiving a layering order of one or more print layers, which are to be layered on a print medium by printing on the print medium, and the print medium;
a function (b) of displaying, on a display device, a preview image representing a virtual three dimensional object of printed matter in which the one or more print layers and the print medium are superimposed and combined in the layering order, the preview image corresponding to an appearance in a three dimensional virtual space;
a function (c) of receiving a change instruction to change the appearance of the three dimensional object;
a function (d) of changing, so that the appearance of the three dimensional object is changed in accordance with the change instruction, at least one of a posture of the three dimensional object in the virtual space, or a viewpoint position and a viewing direction of a virtual camera with respect to the three dimensional object in the virtual space, and of displaying, on the display device, the preview image representing the three dimensional object after changing; and
a function (e) of displaying, on the display device together with the preview image, display information indicating appearance of the three dimensional object represented by the currently displayed preview image.
